(19) United States
(12) Patent Application Publication
(10) Pub. No.: US 2013/0151115 A1
(43) Pub. Date: Jun. 13, 2013

(54) SYSTEM AND METHOD FOR CONTROLLING TORQUE OF ENGINE

(71) Applicant: Youngdae Lee, Uiwang (KR)

(72) Inventor: Youngdae Lee, Uiwang (KR)

(73) Assignees: KIA MOTORS CORPORATION, Seoul (KR); HYUNDAI MOTOR COMPANY, Seoul (KR)

(21) Appl. No.: 13/547,407

(22) Filed: Jul. 12, 2012

(30) Foreign Application Priority Data
Dec. 8, 2011 (KR) 10-2011-0131204

(51) Int. Cl. F02D 28/00

(52) U.S. Cl. 701/102; 903/902; 180/65.21

(57) ABSTRACT

Disclosed is a system and method for controlling engine torque of a hybrid vehicle. In particular, engine mapping information including intake temperature and barometric pressure compensation factors that are the bases for an engine test is received at a control unit. The control unit then calculates a currently available torque of the engine based on the current intake temperature and barometric pressure compensation factors calculated in the engine mapping information, and calculates a current optimal operating line (OOL) torque in the engine through applying an OOL ratio over each RPM in the engine test to the currently available engine torque. The engine test is a test conducted under predetermined conditions for generating a specific fuel consumption map. Advantageously, fuel efficiency may be improved by controlling an engine of a hybrid vehicle at an optimal torque in consideration of current external conditions as well.

### CROSS-REFERENCE TO RELATED APPLICATION

This application claims priority to and the benefit of Korean Patent Application No. 10-2011-0131204 filed in the Korean Intellectual Property Office on Dec. 8, 2011, the entire contents of which are incorporated herein by reference.

### BACKGROUND OF THE INVENTION

(a) Field of the Invention

The present invention relates to a system and method for controlling the engine torque of a hybrid vehicle, and more particularly, to a method for controlling the engine torque of a hybrid vehicle to improve the fuel efficiency of the vehicle by controlling the torque of the engine.

(b) Description of the Related Art

Recently, due to growing environmental concerns and depletion of oil reserves, automotive manufactures have begun to actively pursue cost effective measures for reducing fuel consumption in automobiles. Typically, there are three well known ways of reducing fuel consumption, reducing the weight of the vehicle, reducing exhaust gases and improving fuel efficiency. In particular, fuel efficiency can be improved by controlling an engine of a vehicle to operate at a minimum fuel consumption state.

In hybrid electric vehicles (HEV), the engine torque is generally controlled by operating an engine in an optimal operating line (OOL) at a set engine RPM. For a hybrid control unit (HCU), the fuel efficiency of an engine is achieved through suitable distribution of motor torque under the engine's OOL conditions.

FIGS. 1A and 1B are a diagram illustrating embodiments of specific fuel consumption (SFC) maps for a typical hybrid vehicle engine. Referring to FIG. 1A, for a hybrid vehicle, operating with the engine within a low SFC range (e.g., a range of about 1,500 to 2,500 RPM and about 600 kPa) is advantageous, and thus, for a related art HCU, in order to output the same amount of power as expected on the SFC map, a torque command value is given to the engine to operate within a low SFC range.

However, in order to improve the fuel efficiency in an HEV vehicle, an HCU must use the data in the map illustrated in FIG. 1A which results in a problem. The SFC map data illustrated in FIG. 1A is data obtained through an engine test, which takes into account only suitable conditions during the engine test which may (and often are) different from actual vehicle test conditions, so that when the data is applied to an actual vehicle, there are discrepancies and fuel efficiency is reduced or is much lower than expected.

For example, in the SFC map data in FIG. 1A, the test results were conducted for an engine test in which coolant temperature (TCO) and oil temperature (TOIL) are at a temperature of around 90 degrees after full warm-up, and were conducted when the torque loss of the engine itself was at a minimum level (i.e., after full warm-up of the TCO and TOIL).

However, in an actual vehicle, an FTP test is begun is most likely conducted at 25 degrees and at least 10 minutes elapses until full warm-up of the engine occurs, and particularly for an HEV, full warm up is difficult to maintain due to the sporadic On/Off state of the engine.

The map data in FIG. 1B illustrates an actual vehicle operating state, and is an SFC map of illustrative of when the actual engine loss has increased to 10 Nm because the engine is not fully warmed up. When this map is compared to the map data in FIG. 1A, it can be seen that the positions indicating when the SFC is in a low range are different from those in FIG. 1A.

Accordingly, because conventional HCUs use only test data for controlling the torque of an engine as illustrated in FIG. 1A, various conditions during the operation of an actual vehicle as illustrated in FIG. 1B are not taken into account. Therefore, the fuel efficiency in an actual vehicle is reduced because the vehicle cannot be operated at optimal efficiency as expected.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a system and method for controlling the engine torque of a hybrid vehicle, which can improve the fuel efficiency of the vehicle by controlling the engine torque an optimal efficiency in consideration of actual vehicle operating conditions.

An exemplary embodiment of the present invention provides a method for controlling the engine torque of a hybrid vehicle. In exemplary embodiments the method for controlling engine torque in a hybrid vehicle includes: receiving of mapping information input including intake temperature and barometric pressure compensation factors which are the bases for an engine test; calculating a currently available torque of the engine in consideration of the current intake temperature and barometric pressure compensation factors calculated in the mapping information for the engine; and calculating a current optimal operating line (OOL) torque in the engine by applying an OOL ratio associated with the RPM in the engine test to the currently available torque of the engine. More specifically, the engine test is a test conducted under predetermined conditions for generating a specific fuel consumption (SFC) map.

The currently available torque (A) of the engine may be calculated by means of Equation 1 below.

<Equation 1>

A=(B+C)*D/E

(In Equation 1, B is a maximum torque due to engine RPMs during the engine test, C is a torque loss during the engine test, D is a current intake temperature and barometric pressure compensation value calculated for the engine, and E is an intake temperature and barometric pressure compensation value calculated in the engine test.) The current OOL torque (T) in the engine may be calculated by means of Equation 2 below.

<Equation 2>

T=A*R−L

(In Equation 2, A is the currently available torque from the engine, R is the OOL ratio due RPMs in the engine test, and L is a torque loss under current engine conditions.)

The mapping information may include barometric pressure and maximum torque and torque loss information at each engine RPM, which are the bases for the engine test. The current intake temperature and barometric pressure compensation factors for the engine may be calculated by using information measured by an intake temperature sensor and a barometric pressure sensor. The mapping information including the intake temperature and barometric pressure compensation factors may be formed as a table in a hybrid control unit (HCU).

According to the method for controlling the engine of a hybrid vehicle according to the exemplary embodiments of the present invention, during the generation of an SFC map, because an HCU may calculate OOL torque in consideration of current external conditions (intake temperature, barometric pressure, etc.) of the engine, various external conditions may be reflected in order to operate the vehicle under optimal fuel efficiency.

### BRIEF DESCRIPTION OF THE DRAWINGS

FIGS. 1A and 1B are a diagram illustrating embodiments of specific fuel consumption (SFC) maps for a hybrid vehicle engine.

FIG. 2 is a flowchart of a method for controlling the engine of a hybrid vehicle according to an exemplary embodiment of the present invention.

FIG. 3 is a diagram illustrating the logic of a method for controlling the engine of a hybrid vehicle according to an exemplary embodiment of the present invention.

Description of Symbols

A: Currently available torque of engine

B: Maximum torque by RPM during engine test

C: Torque loss during engine test

D: Intake air temperature and barometric pressure compensation value currently calculated from engine

E: Intake air temperature and barometric pressure compensation value calculated in engine test

T: Optimal operating line (OOL) torque in engine

R: Optimal operating line (OOL) by RPM during engine test

L: Torque loss in current engine conditions

### DETAILED DESCRIPTION OF THE EMBODIMENTS

Hereinafter, exemplary embodiments of the present invention will be described in detail with reference to the drawings.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum).

Furthermore, control logic utilized to execute the exemplary embodiments of the present invention may be embodied as non-transitory computer readable media on a computer readable medium containing executable program instructions executed by a processor, controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

Furthermore, the control unit described herein may be embodied as a single control unit or as a plurality of control units without departing from the overall concept and intent of the illustrative embodiment of the present invention.

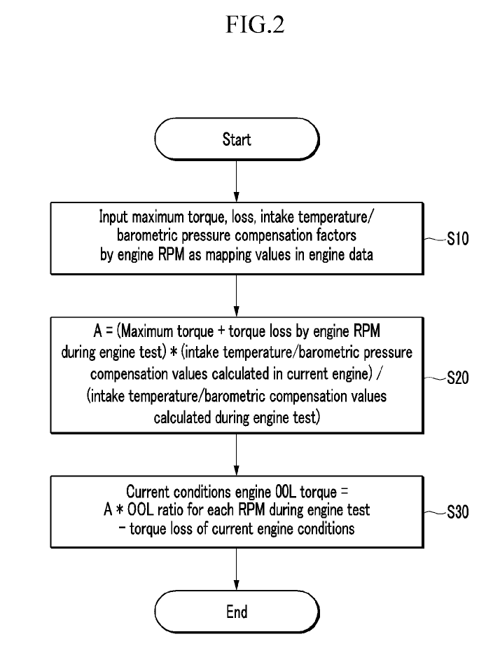

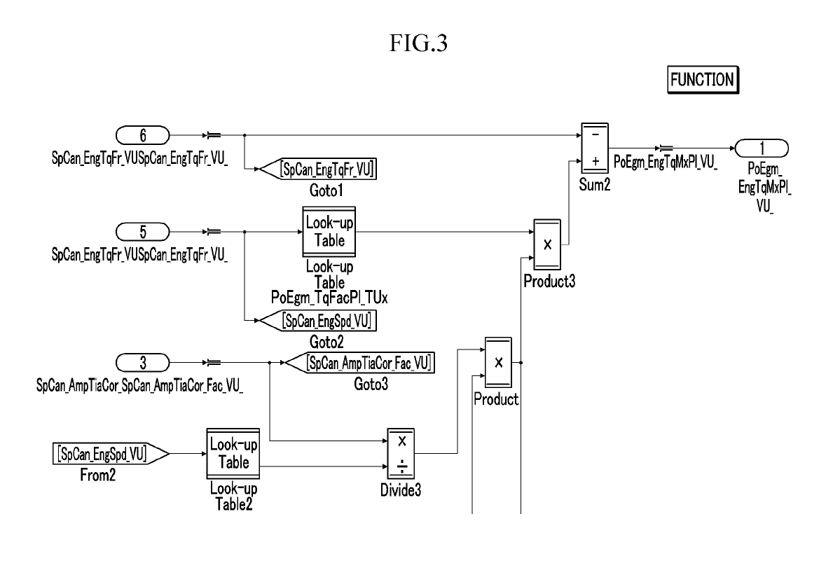

FIG. 2 is a flowchart of a method for controlling the engine of a hybrid vehicle according to an exemplary embodiment of the present invention, and FIG. 3 is a diagram illustrating the control logic of a method for controlling the engine of a hybrid vehicle according to an exemplary embodiment of the present invention. The control logic of the method may be executed by a control unit, e.g., an HCU, installed within the vehicle to control engine operations.

Referring to FIGS. 2 and 3, a method for controlling the engine torque of a hybrid vehicle according to an exemplary embodiment of the present invention is illustrated. First, in S10 mapping information including intake temperature and barometric pressure compensation factors that are the bases for an engine test are input into the control unit Simultaneously or subsequently, the control unit calculates the currently available engine torque based on the current intake temperature and barometric pressure compensation factors calculated in the engine mapping information in S20. A current optimal operating line (OOL) torque in the engine is the calculated by applying an OOL ratio of an associated RPM in the engine test to the currently available engine torque in S30. In some exemplary embodiments of the present invention the mapping information including intake temperature and barometric pressure compensation factors calculated as a reference in the engine test (S10).

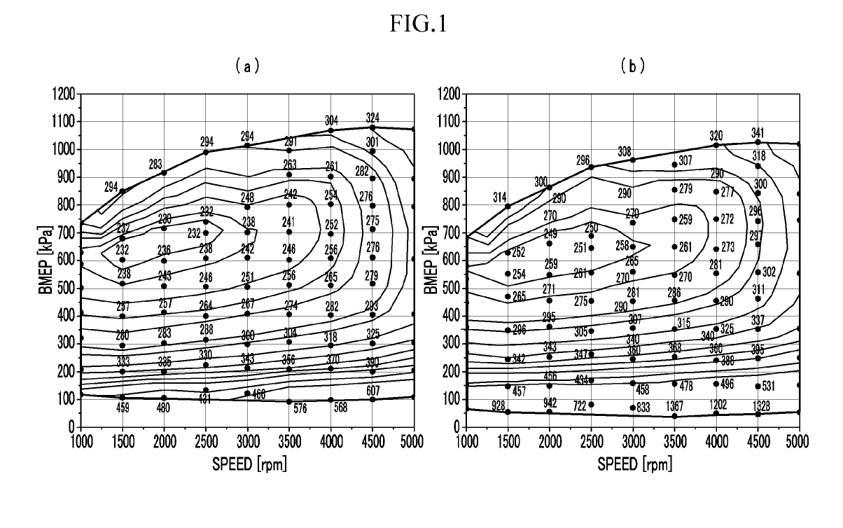

The engine test, as illustrated in the embodiment in FIG. 1A, is a test conducted under predetermined conditions for generating a specific fuel consumption (SFC) map, and in order for the HCU of a hybrid vehicle to output the same power as those values indicated on the map, a torque command value is given to the engine to operate within a low SFC range.

However, as stated above, the engine test is a test that is conducted under predetermined conditions and does not reflect the current conditions of the vehicle. For example, the engine test is performed when coolant temperature (TCO) and oil temperature (TOIL) are at a temperature of around 90° C. after full warm-up, and is also conducted with the barometric pressure and intake temperature within a predetermined range external conditions associated with the environment in which the vehicle is operating are not accounted for at all however.

In one or a plurality of embodiments, the mapping information may include intake temperature and barometric pressure compensation factors, and maximum torque and torque loss information according to barometric pressure and engine RPM. Further, this mapping information may be formed in a table in a hybrid control unit (HCU).

SFC is an indicator of how efficiently fuel is being used when an engine is operating by dividing the flow of fuel by the output. As an indicator of the economy of an engine, the SFC illustrates the amount of fuel consumed per one unit output over a unit of time. Shaft output and shaft torque are illustrated together on an engine level curve, and are factors that can be used to analyze the fuel efficiency of the engine.

According to an exemplary embodiment of the present invention, in order to reflect the current conditions of a vehicle, as illustrated in FIG. 2, the currently available torque A of the engine is calculated in step S20 based on the current intake temperature and barometric pressure compensation factors calculated in the engine mapping information. The currently available torque A of the engine is the torque that may be output by the engine under the current surrounding conditions, and may be calculated by using information received from an intake temperature sensor and a barometric pressure sensor currently installed on the engine.

In one or a plurality of embodiments, the currently available torque A of the engine may be calculated by means of Equation 1 below.

(Equation 1)

A=(B+C)×D/E

In Equation 1, B is a maximum torque at a particular engine RPM during the engine test, C is a torque loss during the engine test, D is a current intake temperature and barometric pressure compensation value calculated for the engine, and E is an intake temperature and barometric pressure compensation value calculated in the engine test.

In step S30, as illustrated in FIG. 2, an OOL ratio per RPM in the engine test is applied to the currently available torque of the engine, to calculate a current OOL torque of the engine. In one or a plurality of embodiments, after the currently available torque of the engine is confirmed, the torque loss of the engine itself may be excluded to derive the maximum torque of the engine under the current surrounding conditions.

The maximum torque of the engine and the OOL torque have a percentage of a mapping value therebetween, so that the HCU may use this value to automatically and dynamically calculate the OOL torque under the current conditions from the maximum engine torque under the current surrounding conditions. When the OOL torque T under the current conditions is calculated, the HCU uses this calculated torque to distribute the torque. In one or a plurality of embodiments, the current OOL torque T of the engine may be calculated by means of Equation 2 below.

(Equation 2)

T=A×R−L

In Equation 2, A is the currently available engine torque, R is the OOL ratio for a particular RPM in the engine test, and L is a torque loss under current engine conditions.

In another or a plurality of other embodiments, Equation 2 may be modified to Equation 3 which may be used to calculate the current OOL torque T of the engine.

(Equation 3)

T=(A−L)×R

In Equation 2, A is the currently available engine torque, R is the OOL ratio for a particular RPM in the engine test, and L is a torque loss under current engine conditions.

Equation 2 and Equation 3 are different in the sequence in which the torque loss L under the current engine conditions is excluded.

Equation 2 excludes the torque loss L value under the current engine conditions after applying the OOL ratio over each of the RPMs in the engine test to the currently available engine torque A, and Equation 3 applies the OOL ratio over each of the RPMs in the engine test after excluding the torque loss L under the current engine conditions from the currently available torque A. In consideration of the level or structure of a hybrid vehicle or the external conditions, one of Equation 2 and Equation 3 may be selected and applied.

According to the method for controlling an engine of a hybrid vehicle according to exemplary embodiments of the present invention as described above, in the generation of an SFC map, an HCU may calculate OOL torque in consideration of current external conditions (intake temperature, barometric pressure, etc.) of an engine, so that various external conditions may be reflected to operate the vehicle at optimal fuel efficiency.

Further, when the HCU forms a driving point in consideration of external conditions of an engine, the development of a logic that takes into consideration the innate characteristics of an engine may be possible. For an engine, during an engine test, a part load/full load of the engine according to engine RPM/torque is set. Part load is generally mapped with exhaust gas prioritized, and full load is mapped with power level prioritized. Accordingly, during an exhaust gas certification test, the engine operating line is set below the engine part load at which less exhaust gas is emitted from the vehicle, and during an acceleration level test, the engine may be set to full load.

To determine these loads, the HCU needs to know the boundary between the engine's part load and full load, and this boundary changes according to external conditions of the engine, so that in the method for controlling an engine according to exemplary embodiments of the present invention, the HCU may be applied to take into consideration the external conditions of the engine for developing an operating line determining logic in consideration of the external conditions of the engine, in order to determine the torque required by the engine while prioritizing exhaust/power. While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for controlling engine torque of a hybrid vehicle, the method comprising:
receiving, by a control unit, engine mapping information including intake temperature and barometric pressure compensation factors that are the bases for an engine test;
calculating, by the control unit, a currently available torque of the engine in consideration of current intake temperature and barometric pressure compensation factors calculated in the engine mapping information; and
calculating, by the control unit, a current optimal operating line (OOL) torque in the engine by applying an OOL ratio at each RPM in the engine test to the currently available torque of the engine,
wherein the engine test is a test conducted under predetermined conditions for generating a specific fuel consumption (SFC) map.

2. The method for controlling engine torque of a hybrid vehicle of claim 1, wherein:
the currently available torque (A) of the engine is calculated by Equation 1 below
<Equation 1>
A=(B+C)*D/E
in Equation 1, B is a maximum torque at a particular engine RPM during the engine test, C is a torque loss during the engine test, D is a current intake temperature and barometric pressure compensation value calculated for the engine, and E is an intake temperature and barometric pressure compensation value calculated in the engine test.

3. The method for controlling engine torque of a hybrid vehicle of claim 2, wherein:
the current OOL torque (T) in the engine is calculated by Equation 2 below
<Equation 2>
T=A*R−L
in Equation 2, A is the currently available torque of the engine, R is the OOL ratio by RPM in the engine test, and L is a torque loss under current engine conditions.

4. The method for controlling engine torque of a hybrid vehicle of claim 1, wherein:
the engine mapping information includes barometric pressure and maximum torque and torque loss information at each engine RPM, which are the bases for the engine test.

5. The method for controlling engine torque of a hybrid vehicle of claim 1, wherein:
the current intake temperature and barometric pressure compensation factors for the engine are calculated by using information measured by an intake temperature sensor and a barometric pressure sensor.

6. The method for controlling engine torque of a hybrid vehicle of claim 1, wherein:
the engine mapping information is formed as a table in a hybrid control unit (HCU).

7. A non-transitory computer readable medium containing program instructions executed by a control unit, the computer readable medium comprising:
program instructions that receive engine mapping information including intake temperature and barometric pressure compensation factors that are the bases for an engine test;
program instructions that calculate a currently available torque of the engine in consideration of current intake temperature and barometric pressure compensation factors calculated in the engine mapping information; and
program instructions that calculate a current optimal operating line (OOL) torque in the engine by applying an OOL ratio at each RPM in the engine test to the currently available torque of the engine,
wherein the engine test is a test conducted under predetermined conditions for generating a specific fuel consumption (SFC) map.

8. The non-transitory computer readable medium of claim 7, wherein:
the currently available torque (A) of the engine is calculated by Equation 1 below
<Equation 1>
A=(B+C)*D/E
in Equation 1, B is a maximum torque at a particular engine RPM during the engine test, C is a torque loss during the engine test, D is a current intake temperature and barometric pressure compensation value calculated for the engine, and E is an intake temperature and barometric pressure compensation value calculated in the engine test.

9. The non-transitory computer readable medium of claim 8, wherein:
the current OOL torque (T) in the engine is calculated by Equation 2 below
<Equation 2>
T=A*R−L
in Equation 2, A is the currently available torque of the engine, R is the OOL ratio by RPM in the engine test, and L is a torque loss under current engine conditions.

10. The non-transitory computer readable medium of claim 7, wherein:
the engine mapping information includes barometric pressure and maximum torque and torque loss information at each engine RPM, which are the bases for the engine test.

11. The non-transitory computer readable medium claim 7, wherein:
the current intake temperature and barometric pressure compensation factors for the engine are calculated by using information measured by an intake temperature sensor and a barometric pressure sensor.

12. The non-transitory computer readable medium of claim 7, wherein:
the engine mapping information is formed as a table in a hybrid control unit (HCU).

13. A system for controlling engine torque of a hybrid vehicle, the method comprising:
a control unit configured to receive engine mapping information including intake temperature and barometric pressure compensation factors that are the bases for an engine test, calculate a currently available torque of the engine in consideration of current intake temperature and barometric pressure compensation factors calculated in the engine mapping information, and calculate a current optimal operating line (OOL) torque in the engine by applying an OOL ratio at each RPM in the engine test to the currently available torque of the engine,
wherein the engine test is a test conducted under predetermined conditions for generating a specific fuel consumption (SFC) map.

14. The system of claim 13, wherein:
the currently available torque (A) of the engine is calculated by Equation 1 below
<Equation 1>
A=(B+C)*D/E
in Equation 1, B is a maximum torque at a particular engine RPM during the engine test, C is a torque loss during the engine test, D is a current intake temperature and barometric pressure compensation value calculated for the engine, and E is an intake temperature and barometric pressure compensation value calculated in the engine test.

15. The system of claim 14, wherein:
the current OOL torque (T) in the engine is calculated by Equation 2 below
<Equation 2>
T=A*R−L
in Equation 2, A is the currently available torque of the engine, R is the OOL ratio by RPM in the engine test, and L is a torque loss under current engine conditions.

16. The system of claim 13, wherein:
the engine mapping information includes barometric pressure and maximum torque and torque loss information at each engine RPM, which are the bases for the engine test.

17. The system claim 13, wherein:
the current intake temperature and barometric pressure compensation factors for the engine are calculated by using information measured by an intake temperature sensor and a barometric pressure sensor.

18. The system of claim 13, wherein:
the engine mapping information is formed as a table in a hybrid control unit (HCU).
